(19) United States
(12) Patent Application Publication
(10) Pub. No.: US 2025/0253402 A1
(43) Pub. Date: Aug. 7, 2025

(54) ELECTROCHEMICAL APPARATUS AND ELECTRONIC APPARATUS

(71) Applicant: Ningde Amperex Technology Limited, Ningde, Fujian (CN)

(72) Inventors: Ben WANG, Ningde, (CN); Shaoyun ZHOU, Ningde, (CN); Junhua JIAN, Ningde, (CN); Xianhai LU, Ningde, (CN)

(73) Assignee: Ningde Amperex Technology Limited, Ningde, Fujian (CN)

(21) Appl. No.: 19/044,840

(22) Filed: Feb. 4, 2025

(30) Foreign Application Priority Data
Feb. 6, 2024 (CN) 202410168871.8

(51) Int. Cl. H01M 10/0568; H01M 10/0569

(52) U.S. Cl. CPC H01M 10/0568; H01M 10/0569; H01M 2300/0025

(57) ABSTRACT

An electrochemical apparatus includes a positive electrode plate and an electrolyte. The positive electrode plate includes a positive electrode active material layer. The positive electrode active material layer includes a positive electrode active material. The positive electrode active material includes a lithium composite oxide. The lithium composite oxide includes the lithium element and at least one element selected from the cobalt element, the nickel element, the manganese element, and the aluminum element. A surface layer of the positive electrode active material has a rock salt phase structure and includes the tungsten element. Based on a total mass of the positive electrode active material, a mass percentage of the tungsten element is B, where 0.01%≤B≤1%. The electrolyte includes an ionic liquid represented by a formula R:

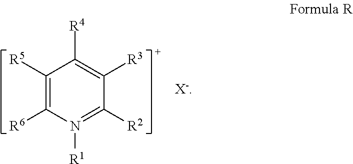

### CROSS-REFERENCE TO RELATED APPLICATION

This application claims the benefit of priority from the Chinese Patent Application No. 202410168871.8, filed on Feb. 6, 2024, the entire content of which is incorporated herein by reference.

### TECHNICAL FIELD

This application relates to the field of electrochemical energy storage, and specifically, to an electrochemical apparatus and an electronic apparatus.

### BACKGROUND

The use of high-nickel positive electrode active materials can increase energy density of electrochemical apparatuses and also reduce costs. However, during the use of the electrochemical apparatuses, as the content of nickel increases, the positive electrode active materials undergo phase transition, which causes volume changes and structural damage, affecting the high-temperature storage performance. Therefore, improvement in the stability of the positive electrode active materials in the electrochemical apparatuses and the storage performance of the electrochemical apparatuses is expected.

### SUMMARY

This application provides an electrochemical apparatus. The electrochemical apparatus includes a positive electrode plate and an electrolyte, where the positive electrode plate includes a positive electrode active material layer, the positive electrode active material layer includes a positive electrode active material, the positive electrode active material includes a lithium composite oxide, the lithium composite oxide includes the lithium element and at least one element selected from the cobalt element, the nickel element, the manganese element, and the aluminum element, a surface layer of the positive electrode active material has a rock salt phase structure and includes the tungsten element; and based on a total mass of the positive electrode active material, a mass percentage of the tungsten element is B, where 0.01%≤B≤1%;
the electrolyte includes an ionic liquid represented by a formula R:

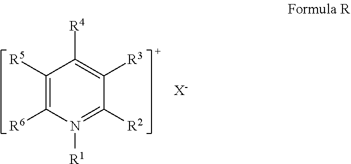

where in a cation, R¹ is selected from a C₁-C₈ alkyl group; R² to R⁶ each are independently selected from a hydrogen atom and a fluorine atom; an anion X⁻ is selected from a chloride ion, a bromide ion, an iodide ion, a cyano group ion, a hexafluorophosphate radical, a perchlorate radical, a tetrafluoroborate radical, a bis(trifluoromethylsulfonyl)imide ion, and a sulfate radical; and based on a total mass of the electrolyte, a mass percentage of the cation of the ionic liquid represented by the formula R is A, where 0.05%≤A≤5%, P1=A/B, and 0.08≤P1≤300.

In some embodiments, in the positive electrode active material, a mass percentage of the nickel element in a total mass of metal elements excluding the lithium element is p, where 50%≤p<100%, where P2=A/p, and 0.001≤P2≤0.08. In some embodiments, 0.01≤P2≤0.06. In some embodiments, 0.5≤P1≤50.

In some embodiments, the electrolyte further includes a cyclic ester, the cyclic ester includes at least one of ethylene carbonate (EC), vinylene carbonate (VC), or fluoroethylene carbonate (FEC), and based on the total mass of the electrolyte, a mass percentage of the cyclic ester is C, where 1%≤C≤15%, P3=A/C, and 0.005≤P3≤3.

In some embodiments, the cation of the ionic liquid represented by the formula R is selected from the following structures:

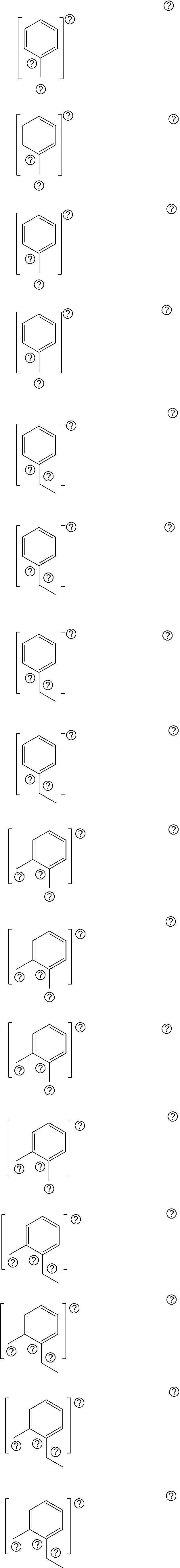

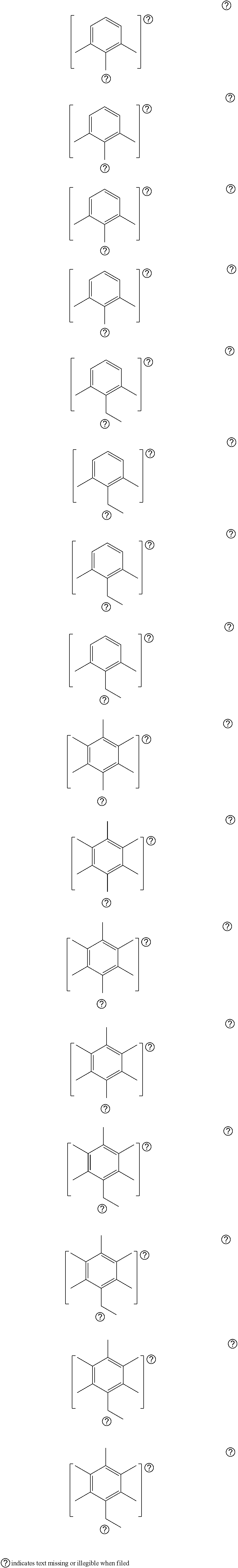

In some embodiments, the sulfate radical is selected from the following structures:

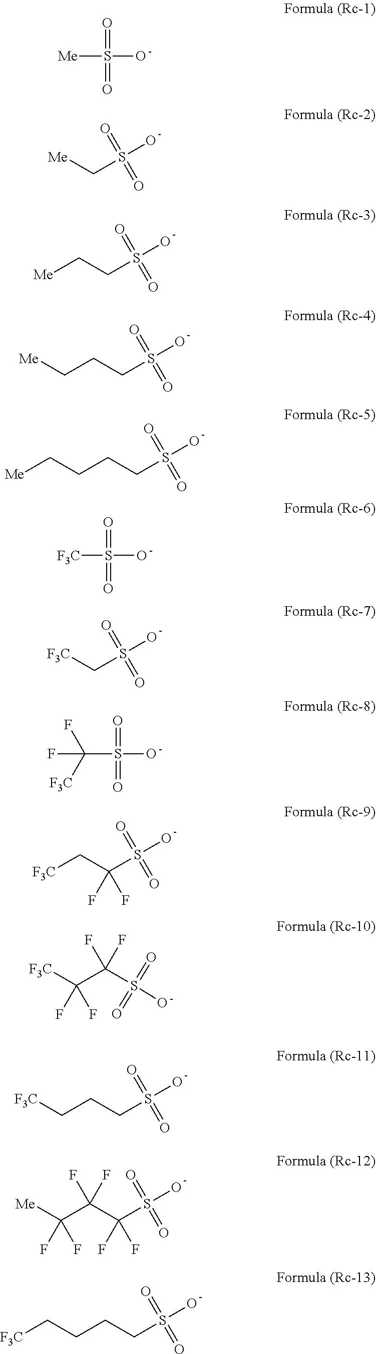

In some embodiments, the electrolyte further includes a cyclic sulfur-oxygen double bond compound; the cyclic sulfur-oxygen double bond compound includes at least one of 1,3-propane sultone (PS), ethylene sulfate (DTD), or methylene methanedisulfonate (MMDS); and based on the total mass of the electrolyte, a mass percentage of the cyclic sulfur-oxygen double bond compound is S, where 1%≤S≤10%. In some embodiments, P4=A/S, and 0.01≤P4≤1.

An embodiment of this application further provides an electronic apparatus including the foregoing electrochemical apparatus.

In this application, a percentage of a rock salt phase in the positive electrode active material can be controlled by controlling the mass percentage of the tungsten element in the positive electrode active material to enhance the structural stability of the positive electrode active material. Besides, the mass percentage A of the cation of the ionic liquid shown in the formula R is controlled, so that the ionic liquid can be fully dissolved in the electrolyte and complexed with the tungsten element on the surface of a positive electrode, thereby improving high-temperature storage performance of the electrochemical apparatus.

### DETAILED DESCRIPTION

The following embodiments can help persons skilled in the art understand this application more comprehensively, but do not limit this application in any manner.

An embodiment of this application provides an electrochemical apparatus. The electrochemical apparatus includes a positive electrode plate and an electrolyte. In some embodiments, the positive electrode plate includes a positive electrode active material layer, and the positive electrode active material layer includes a positive electrode active material. In some embodiments, the positive electrode active material includes a lithium composite oxide, and the lithium composite oxide includes the lithium element and at least one element selected from the cobalt element, the nickel element, the manganese element, and the aluminum element. In some embodiments, a surface layer of the positive electrode active material has a rock salt phase structure and includes the tungsten element. In some embodiments, based on a total mass of the positive electrode active material, a mass percentage of the tungsten element is B, where 0.01%≤B≤1%. In some embodiments, B may be 0.01%, 0.1%, 0.5%, 1.0%, or any value in a range defined by any two of these values. The mass percentage of the tungsten element is controlled within the foregoing range, so that a percentage of a rock salt phase in the positive electrode active material can be controlled, which facilitates the structural stability of the positive electrode active material to some extent. When the value of B is greater than 1%, an excessive percentage of the rock salt phase causes capacity decay of the positive electrode. When the value of B is less than 0.01%, the percentage of the rock salt phase is excessively low, and therefore the structure of the positive electrode active material cannot be stabilized.

In some embodiments, the electrolyte includes an ionic liquid represented by a formula R:

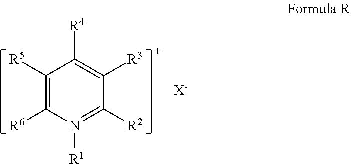

where in a cation, R¹ is selected from a C₁-C₈ alkyl group; R² to R⁶ each are independently selected from a hydrogen atom and a fluorine atom; and an anion X⁻ is selected from a chloride ion, a bromide ion, an iodide ion, a cyano group ion, a hexafluorophosphate radical, a perchlorate radical, a tetrafluoroborate radical, a bis(trifluoromethylsulfonyl)imide ion, and a sulfate radical. The ionic liquid can participate in formation of an interface film to stabilize the surface structure of the positive electrode and prevent damage while inhibiting decomposition of the electrolyte on the surface of the positive electrode, thereby significantly alleviating gas production in high-temperature storage of the electrochemical apparatus. In some embodiments, based on a total mass of the electrolyte, a mass percentage of the cation of the ionic liquid represented by the formula R is A, where 0.05%≤A≤5%. In some embodiments, A may be 0.05%, 0.1%, 0.5%, 1%, 3%, 5%, or any value in a range defined by any two of these values. The mass percentage A of the cation of the ionic liquid shown in the formula R is controlled within the foregoing range, so that the ionic liquid can be fully dissolved in the electrolyte and complex with the tungsten element on the surface of the positive electrode, thereby improving high-temperature storage performance of the electrochemical apparatus.

In some embodiments, a ratio P1=A/B of the mass percentage A of the cation of the ionic liquid in the electrolyte represented by the formula R to the mass percentage B of the tungsten element in the positive electrode active material satisfies an equation 0.08≤P1≤300. When P1 falls within the foregoing range, the ionic liquid represented by the formula R can stably complex with the surface of the rock salt phase, reducing interfacial reactions caused by surface Li; when P1 is less than 0.08, a complete covering layer cannot be formed, resulting in continuous consumption of active Li; and when P1 is greater than 300, polarization increases. In some embodiments, 0.08≤P1≤300. In some embodiments, 0.5≤P1≤50.

In some embodiments, in the positive electrode active material, a mass percentage of the nickel element in a total mass of metal elements excluding the lithium element is p, where 50%≤p<100%. In some embodiments, p may be 50%, 60%, 70%, 80%, 90%, or any value in a range defined by any two of these values. With p controlled within the foregoing range, the ionic liquid represented by the formula R can stably cover the microcrack surface of the positive electrode active material layer with a bidentate structure formed by anions and cations of the ionic liquid, thereby preventing side reactions between an interface and the electrolyte.

In some embodiments, P2=A/p, and 0.001≤P2≤0.08. When P2 is within the foregoing range, exposure of microcracks in the positive electrode active material layer can be effectively alleviated. When P2 is greater than 0.08, interface impedance increases. When P2 is less than 0.001, the microcracks cannot be completely covered. In some embodiments, 0.01≤P2≤0.06.

In some embodiments, 0.05%≤A≤3%. When A is greater than 3%, it is easy to cause deterioration of the positive electrode impedance. When 0.05%≤A≤3%, the positive electrode impedance increase can be weakened while the high-temperature storage performance is improved.

In some embodiments, the electrolyte further includes a cyclic ester, and the cyclic ester includes at least one of ethylene carbonate, vinylene carbonate, or fluoroethylene carbonate. In some embodiments, based on the total mass of the electrolyte, a mass percentage of the cyclic ester is C, where 1%≤C≤15%. In some embodiments, C may be 1%, 5%, 8%, 10%, or 15%, or any value in a range defined by any two of these values. The above cyclic carbonate has a high dielectric constant and a high polarity, which can facilitate dissociation of lithium salts, thereby improving conductivity. In some embodiments, P3=A/C, and 0.005≤P3≤3. When P3 is within the foregoing range, kinetic performance of the electrochemical apparatus can be further improved. In some embodiments, 0.005≤P3≤0.5.

In some embodiments, the cation of the ionic liquid represented by the formula R is selected from the following structures:

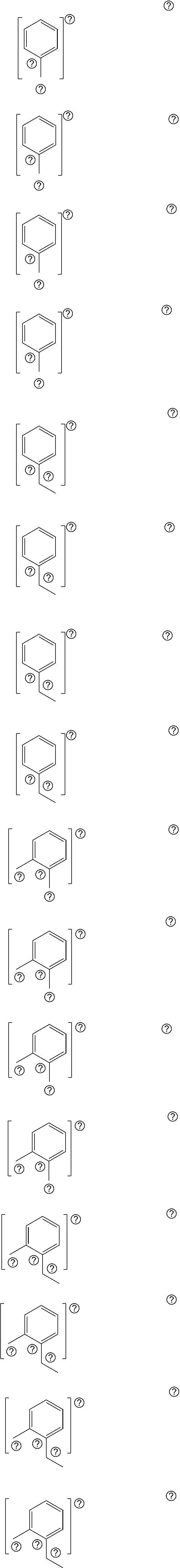

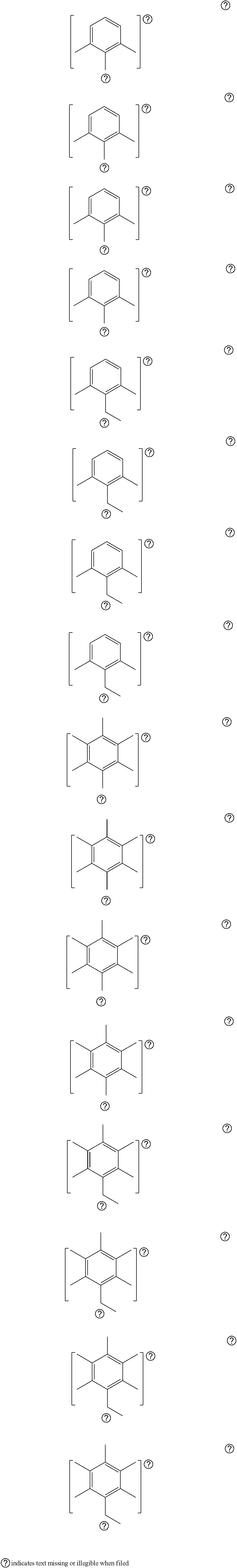

In some embodiments, the sulfate radical as an anion is selected from the following structures:

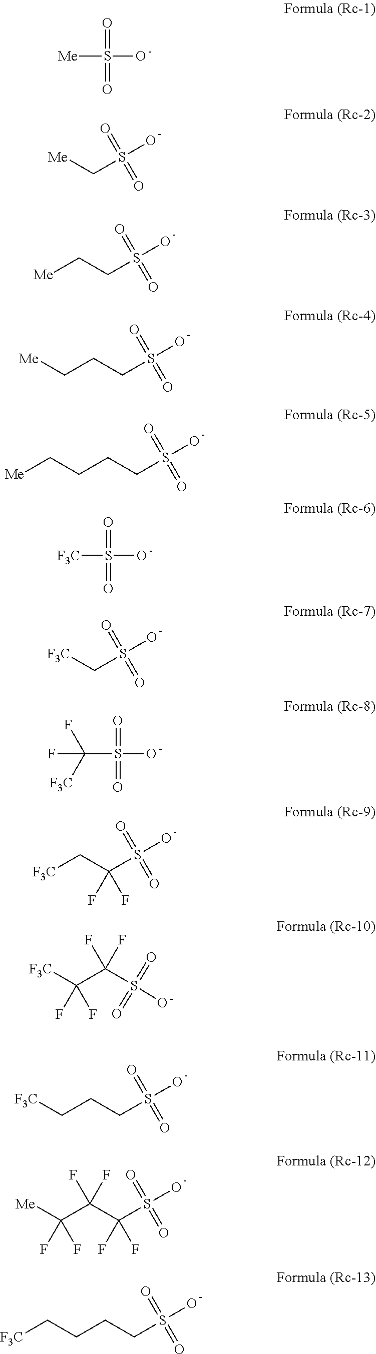

In some embodiments, the electrolyte further includes a cyclic sulfur-oxygen double bond compound; and the cyclic sulfur-oxygen double bond compound includes at least one of 1,3-propane sultone (PS), ethylene sulfate (DTD), or methylene methanedisulfonate (MMDS). When a cyclic sulfur-oxygen double bond compound is added to the electrolyte, the high-temperature storage performance of the electrochemical apparatus can be further improved.

In some embodiments, based on the total mass of the electrolyte, a mass percentage of the cyclic sulfur-oxygen double bond compound is S, where 1%≤S≤10%. In some embodiments, P4=A/S, and 0.01≤P4≤1. When P4 is within the foregoing range, the high-temperature storage performance of the electrochemical apparatus can be well improved. In some embodiments, 0.05≤P4≤1.

In some embodiments, the positive electrode plate further includes a positive electrode current collector, and the positive electrode active material layer is located on one side or both sides of the positive electrode current collector. In some embodiments, the positive electrode current collector may be an aluminum foil, and certainly may be other positive electrode current collectors commonly used in the art. In some embodiments, a thickness of the positive electrode current collector may be 1 μm to 50 m.

In some embodiments, the positive electrode active material layer may further include a conductive agent and a binder. The conductive agent in the positive electrode active material layer may include at least one of conductive carbon black, flake graphite, graphene, or carbon nanotubes. In some embodiments, the binder in the positive electrode active material layer may include at least one of polyvinylidene fluoride, vinylidene fluoride-hexafluoropropylene copolymer, styrene-acrylate copolymer, styrene-butadiene copolymer, polyamide, polyacrylonitrile, polyacrylate ester, polyacrylic acid, polyacrylate, sodium carboxymethyl cellulose, polyvinyl acetate, polyvinylpyrrolidone, polyvinyl ether, polymethyl methacrylate, polytetrafluoroethylene, or polyhexafluoropropylene. In some embodiments, a mass ratio of the positive electrode active material, the conductive agent, and the binder in the positive electrode active material layer is (80-99):(0.1-10):(0.1-10). However, this is merely an example and any other suitable mass ratio can be used.

In some embodiments, the electrochemical apparatus further includes a negative electrode plate. The negative electrode plate includes a negative electrode current collector and a negative electrode active material layer, and the negative electrode active material layer is located on one side or both sides of the negative electrode current collector. In some embodiments, the negative electrode active material layer includes a negative electrode active material, and the negative electrode active material may include graphite, a silicon-based material, and the like. In some embodiments, the silicon-based material includes at least one of silicon, a silicon-oxygen material, a silicon-carbon material, or a silicon-oxygen-carbon material. In some embodiments, the negative electrode current collector may be at least one of a copper foil current collector, a nickel foil current collector, or a carbon-based current collector. The negative electrode active material layer may further include a conductive agent, a binder, and a thickener (for example, sodium carboxymethyl cellulose). In some embodiments, the conductive agent in the negative electrode active material layer may include at least one of conductive carbon black, Ketjen black, flake graphite, graphene, carbon nanotubes, or carbon fiber. In some embodiments, the binder in the negative electrode active material layer may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio of the negative electrode active material, the thickener, and the binder in the negative electrode active material layer may be (97-98):(0.2-0.6):(1.8-2.4). It should be understood that this is merely an example and any other suitable mass ratio can be used.

In some embodiments, the electrochemical apparatus further includes a separator. The positive electrode plate and the negative electrode plate are separated by the separator disposed therebetween.

In some embodiments, the separator includes at least one of polyethylene, polypropylene, polyvinylidene fluoride, polyethylene glycol terephthalate, polyimide, or aramid. For example, polyethylene is at least one selected from high-density polyethylene, low-density polyethylene, or ultrahigh-molecular-weight polyethylene. Especially, polyethylene and polypropylene have a good effect on preventing short circuits and can improve stability of a battery through a shutdown effect. In some embodiments, a thickness of the separator ranges from approximately 3 μm to 20 m.

In some embodiments, a surface of the separator may further include a porous layer. The porous layer is disposed on at least one surface of the separator. The porous layer includes inorganic particles and the binder. The inorganic particles are selected from at least one of aluminum oxide (Al₂O₃), silicon oxide (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, a pore diameter of the separator ranges from approximately 0.01 m to 1 μm. The binder of the porous layer is at least one selected from polyvinylidene fluoride, a vinylidene fluoride-hexafluoropropylene copolymer, polyamide, polyacrylonitrile, polyacrylate ester, polyacrylic acid, polyacrylate, sodium carboxymethyl cellulose, polyvinylpyrrolidone, polyvinyl ether, polymethyl methacrylate, polytetrafluoroethylene, or polyhexafluoropropylene. The porous layer on the surface of the separator can improve heat resistance, oxidation resistance, and electrolyte infiltration performance of the separator, and enhance adhesion between the separator and the electrode plates.

In some embodiments, the electrochemical apparatus includes a lithium-ion battery. However, this application is not limited thereto. In some embodiments, the electrolyte further includes at least one of fluoroether, fluoroethylene carbonate, or ether nitrile. In some embodiments, the electrolyte further includes a lithium salt. The lithium salt includes lithium bis(fluorosulfonyl)imide and lithium hexafluorophosphate. A concentration of the lithium salt is 1 mol/L to 2 mol/L, and a mass ratio of the lithium bis(fluorosulfonyl)imide to the lithium hexafluorophosphate is 0.06 to 5. In some embodiments, the electrolyte may further include a non-aqueous solvent. The non-aqueous solvent may be a carbonate compound, a carboxylate compound, an ether compound, another organic solvent, or a combination thereof.

The carbonate compound may be a linear carbonate compound, a fluoride carbonate compound, or a combination thereof.

An example of the linear carbonate compound is diethyl carbonate (DEC), dimethyl carbonate (DMC), dipropyl carbonate (DPC), methyl propyl carbonate (MPC), ethylene propyl carbonate (EPC), ethyl methyl carbonate (MEC), or a combination thereof. An example of the carboxylate compound is methyl acetate, ethyl acetate, n-propyl acetate, tert-butyl acetate, methyl propionate, ethyl propionate, propyl propionate, γ-butyrolactone, decalactone, valerolactone, mevalonolactone, caprolactone, methyl formate, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate, or a combination thereof.

An embodiment of this application further provides an electronic apparatus including the foregoing electrochemical apparatus. The electronic apparatus in this embodiment of this application is not particularly limited, and may be any known electronic apparatus used in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disk, a transceiver, an electronic notepad, a calculator, a memory card, a portable recorder, a radio, a standby power source, a motor, an automobile, a motorcycle, a power-assisted bicycle, a bicycle, a drone, a lighting appliance, a toy, a game console, a clock, an electric tool, a flash lamp, a camera, a large household battery, and a lithium-ion capacitor.

Some specific examples and comparative examples are listed below to better illustrate this application. Lithium-ion batteries are used for illustration.

### Example 1-1

Preparation of negative electrode plate: A negative electrode active material artificial graphite, a conductive agent conductive carbon black (Super P), a thickener sodium carboxymethyl cellulose (CMC), a binder styrene-butadiene rubber (SBR), and lithium polyacrylate were mixed at a mass ratio of 92:1.5:0.5:1:5. Deionized water was added as a solvent to prepare a negative electrode slurry with a solid content of 54%. Stirring was performed under the action of a vacuum mixer to form a negative electrode slurry with an even slurry system. The conductive agent Super P and the binder SBR were mixed at a mass ratio of 9:1, and then the deionized water was added as the solvent to prepare a conductive layer slurry with a solid content of 10%. The conductive layer slurry and the negative electrode slurry were evenly applied onto one surface of a negative electrode current collector copper foil with a thickness of 8 μm in sequence, and the copper foil was dried at 85° C. to obtain a negative electrode having one surface coated with a conductive layer with a thickness of 2 μm and a negative electrode active material layer with a thickness of 100 μm. Then the foregoing steps were repeated on the other surface of the negative electrode, to obtain a negative electrode with both sides coated. After coating was completed, the negative electrode was cold-pressed and cut into a size of 90.7 mm×393 mm for later use.

Preparation of positive electrode plate: Nickel sulfate (NiSO₄), cobalt sulfate (CoSO₄), and manganese sulfate (MnSO₄) at an element mass ratio of 0.8:0.1:0.1 were used as a nickel source, a cobalt source, and a manganese source to prepare a 3 mol/L mixed solution. Sodium hydroxide was used as a precipitant to prepare a sodium hydroxide solution with a concentration of about 3 mol/L. An ammonia water was used as a complexing agent to prepare an ammonia solution with a concentration of about 2 mol/L. The three solutions were simultaneously dropwise added to a reaction kettle, with pH controlled at about 11.5 and a temperature of the reaction kettle maintained at about 50° C. After stirring, filtering, washing, and drying were performed to obtain a lithium nickel cobalt manganate precursor. The lithium nickel cobalt manganate precursor and WO₃ powder were mixed and ground, and the amount of the used WO₃ powder used was controlled so that a mass percentage of the tungsten (W) element in the positive electrode active material was 0.02%. Then, calcination was performed at 700° C. in an oxygen atmosphere for 12 h to obtain a lithium nickel cobalt manganate positive electrode active material (Li₁Ni_{0.8}Co_{0.1}Mn_{0.1} O₂) with a rock salt phase surface layer, where the surface layer was doped with the tungsten element, and a mass percentage of the nickel element in the total mass of the metal elements excluding the lithium element was 80%.

The positive electrode active material (Li₁Ni_{0.8}Co_{0.1}Mn_{0.1} O₂), the conductive agent conductive carbon black (Super P), and a binder polyvinylidene fluoride (PVDF) were mixed at a mass ratio of 97:1.4:1.6. N-methylpyrrolidone (NMP) was added as a solvent to prepare a slurry with a solid content of 75%. The slurry was stirred under the action of a vacuum mixer to form a positive electrode slurry with an even system. The positive electrode slurry was evenly applied onto a surface of a positive electrode current collector aluminum foil with a thickness of m, and the aluminum foil was dried at 85° C. to obtain a positive electrode having one surface coated with a positive electrode active material, where the positive electrode active material has a thickness of 110 μm. Then the foregoing steps were repeated on the other surface of the positive electrode, to obtain a positive electrode with both sides coated with the positive electrode active material. After coating was completed, the positive electrode was cold-pressed and cut into a size of 89.5 mm×388 mm for later use.

Preparation of separator: A polyethylene (PE) porous film with a thickness of 5 m (provided by Celgard Company) was used.

Preparation of electrolyte: Base solvents dimethyl carbonate (DMC) and propylene carbonate (PC) were mixed at a mass ratio of 6:4 in an argon-atmosphere glove box with a moisture content of less than 10 ppm. A lithium salt lithium hexafluorophosphate (LiPF₆) with a mass percentage WI was added to the base solvents, dissolved, and mixed to uniformity. Then a cation formula R-5 of a compound that has a mass percentage Wr and that is represented by a general formula (R) was added, where X⁻ is an electrolyte obtained by stirring Rc-1 to uniformity. Based on a mass of the electrolyte, a mass percentage of the lithium salt LiPF₆ was 12.5%; the mass percentage Wr of the cation of the compound represented by the general formula (R) was 0.5%; and the remaining was the base solvents.

Preparation of lithium-ion battery: The prepared positive electrode plate, separator, and negative electrode plate were stacked in sequence with the separator positioned between the positive electrode plate and the negative electrode plate for separation, and then the resulting stack was wound to obtain an electrode assembly. After tab welding, the electrode assembly was placed into an aluminum laminated film packaging housing, the aluminum laminated film packaging housing was dried in a vacuum oven at 85° C. for 12 hours to remove moisture, and the prepared electrolyte was injected, followed by processes such as vacuum sealing, standing, formation (charging to 3.3V at a constant current of 0.02C), shaping, and capacity testing to obtain a lithium-ion battery.

Comparative example 1-1 was the same as Example 1-1 except that the compound represented by the formula R was not added to the electrolyte. Besides, related preparation parameters and performance parameters of Examples 1-2 to 1-25 and Comparative examples 1-1 to 1-6 are shown in Table 1. Except for indicated differences, other aspects are the same as those in Example 1-1.

In addition, in this application, the following methods were used to measure corresponding parameters.

High-temperature storage performance test:

The lithium-ion battery was placed in a constant-temperature environment at 25° C. and left standing for 5 minutes to make the lithium-ion battery reach a constant temperature. The battery was charged at a constant current of 0.2C to 4.3V, and then charged at a constant voltage to a current of 0.05C. A thickness of the lithium-ion battery was recorded as an initial thickness. The lithium-ion battery was transferred to a high-temperature oven at 80° C. and stored for 24 h. A thickness after 24 h was recorded as a storage thickness. A thickness swelling rate of the lithium-ion battery was calculated and used as an indicator of a gas production amount during high-temperature storage of the lithium-ion battery.

$$Thickness swelling rate = ( storage thickness - initial thickness ) / initial thickness \times 100 \% .$$

Table 1 shows various parameters and evaluation results.

TABLE 1

| | | | Mass | | |
|---|---|---|---|---|---|
| | Compound represented by | | percentage | | |
| | formula R | | B of | | |
| | | Mass | tungsten | P1 | High-temperature |
| | | percentage | element | (A/B) | storage swelling |
| Example | Type | A (wt %) | (wt %) | value | rate (%) |
| Example 1-1 | Formula R-5 + | 0.5 | 0.02 | 25 | 9.7 |
| | Formula Rc-1 | | | | |
| Example 1-2 | Formula R-5 + | 0.05 | 0.02 | 2.5 | 8.9 |
| | Formula Rc-1 | | | | |
| Example 1-3 | Formula R-5 + | 0.1 | 0.02 | 5 | 7.3 |
| | Formula Rc-1 | | | | |
| Example 1-4 | Formula R-5 + | 1 | 0.02 | 50 | 8.2 |
| | Formula Rc-1 | | | | |
| Example 1-5 | Formula R-5 + | 3 | 0.02 | 150 | 9.6 |
| | Formula Rc-1 | | | | |
| Example 1-6 | Formula R-5 + | 5 | 0.02 | 250 | 7.7 |
| | Formula Rc-1 | | | | |
| Example 1-7 | Formula R-5 + | 0.1 | 0.01 | 10 | 8.2 |
| | Formula Rc-1 | | | | |
| Example 1-8 | Formula R-5 + | 0.1 | 0.05 | 2 | 7.9 |
| | Formula Rc-1 | | | | |
| Example 1-9 | Formula R-5 + | 0.1 | 0.1 | 1 | 7.6 |
| | Formula Rc-1 | | | | |
| Example 1-9 | Formula R-5 + | 0.1 | 0.3 | 0.33 | 7.8 |
| | Formula Rc-1 | | | | |
| Example 1-10 | Formula R-5 + | 0.1 | 0.5 | 0.2 | 9.9 |
| | Formula Rc-1 | | | | |
| Example 1-11 | Formula R-5 + | 0.1 | 1 | 0.1 | 8.9 |
| | Formula Rc-1 | | | | |
| Example 1-12 | Formula R-1 + | 0.1 | 0.02 | 5 | 9.0 |
| | Formula Rc-1 | | | | |
| Example 1-13 | Formula R-3 + | 0.1 | 0.02 | 5 | 9.2 |
| | Formula Rc-1 | | | | |
| Example 1-14 | Formula R-4 + | 0.1 | 0.02 | 5 | 8.5 |
| | Formula Rc-1 | | | | |
| Example 1-15 | Formula R-6 + | 0.1 | 0.02 | 5 | 8.6 |
| | Formula Rc-1 | | | | |
| Example 1-16 | Formula R-7 + | 0.1 | 0.02 | 5 | 7.5 |
| | Formula Rc-1 | | | | |
| Example 1-17 | Formula R-8 + | 0.1 | 0.02 | 5 | 8.6 |
| | Formula Rc-1 | | | | |
| Example 1-18 | Formula R-9 + | 0.1 | 0.02 | 5 | 7.8 |
| | Formula Rc-1 | | | | |
| Example 1-19 | Formula R-5 + | 3.5 | 0.012 | 300 | 9.5 |
| | Formula Rc-1 | | | | |
| Example 1-20 | Formula R-5 + | 0.2 | 0.89 | 0.09 | 9.8 |
| | Formula Rc-1 | | | | |
| Example 1-21 | Formula R-6 + | 1.2 | 0.8 | 1.5 | 7.6 |
| | Formula Rc-3 | | | | |
| Example 1-22 | Formula R-6 + | 1.4 | 1 | 1.4 | 8.3 |
| | Formula Rc-6 | | | | |
| Example 1-23 | Formula R-6 + | 1.6 | 0.5 | 3.2 | 7.8 |
| | Formula Rc-6 | | | | |
| Example 1-24 | Formula R-6 + | 1.9 | 0.05 | 38 | 9.7 |
| | Formula Rc-8 | | | | |
| Example 1-25 | Formula R-6 + | 0.8 | 0.02 | 40 | 7.9 |
| | Formula Rc-9 | | | | |
| Comparative | / | / | 0.02 | / | 23.7 |
| example 1-1 | | | | | |
| Comparative | Formula R-5 + | 0.5 | / | / | 22.1 |
| example 1-2 | Formula Rc-1 | | | | |
| Comparative | Formula R-5 + | 5.5 | 0.2 | 27.5 | 22.8 |
| example 1-3 | Formula Rc-1 | | | | |
| Comparative | Formula R-5 + | 0.001 | 0.01 | 0.1 | 19.6 |
| example 1-4 | Formula Rc-1 | | | | |
| Comparative | Formula R-5 + | 0.07 | 1 | 0.07 | 18.5 |
| example 1-5 | Formula Rc-1 | | | | |
| Comparative | Formula R-5 + | 5 | 0.015 | 333.3 | 18.3 |
| example 1-6 | Formula Rc-1 | | | | |

Note:
In Table 1, “/” indicates the absence of the component.

Through comparison between Examples 1-1 to 1-25 and Comparative example 1-1, it can be learned that the high-temperature storage swelling rate of the lithium-ion battery can be significantly reduced by adding the ionic liquid represented by the formula R to the electrolyte, where 0.05%≤A≤5% and 0.08≤P1≤300. Through comparison between Examples 1-1 to 1-25 and Comparative example 1-2, it can be learned that the high-temperature storage swelling rate of the lithium-ion battery can be significantly reduced by doping the surface layer of the positive electrode active material with the W element, where 0.0100≤B≤1%. Through comparison between Examples 1-1 to 1-6 and Comparative examples 1-3 and 1-4, it can be learned that the high-temperature storage swelling rate of the lithium-ion battery can be significantly reduced when 0.05%≤A≤50%. Through comparison between Examples 1-1 to 1-11, 1-19 and 1-20 and Comparative examples 1-5 and 1-6, it can be learned that the high-temperature storage swelling rate of the lithium-ion battery can be significantly reduced when 0.08≤P1≤300. During overall performance evaluation of a lithium-ion battery, attention should be paid to high-temperature storage performance of the lithium-ion battery. Usually, a high-temperature storage thickness swelling rate greater than 10% is unacceptable. Therefore, the high-temperature storage swelling rates of Comparative examples 1-1 to 1-6 are unacceptable.

Through comparison between Examples 1-1 to 1-6, it can be learned that as A increases, the high-temperature storage swelling rate of the lithium-ion battery first decreases, then increases, then decreases, then increases, and then decreases again. Through comparison between Examples 1-7 to 1-11, it can be learned that as B increases, the high-temperature storage swelling rate of the lithium-ion battery first decreases, then increases, and then decreases again.

From Example 1-3 and Examples 1-12 to 1-18, it can be learned that the high-temperature storage swelling rate of the lithium-ion battery varies with changes in the compound represented by the formula R. Similarly, from Examples 1-21 to 1-25, it can be learned that the high-temperature storage swelling rate of the lithium-ion battery varies with changes in the compound represented by the formula R.

Table 2 shows related preparation parameters and performance parameters. In Examples 2-1 to 2-13, the percentage of the Ni element is further adjusted based on Example 1-1. Except for the differences shown in Table 2, other parameters are the same as those in Example 1-1.

TABLE 2

| | | | Mass | | | High- |
|---|---|---|---|---|---|---|
| | Compound represented by | | percentage | | | temperature |
| | formula R | | B of | | | storage |
| | | Mass | tungsten | Mass | P2 | swelling |
| | | percentage | element | percentage | (A/p) | rate |
| Example | Type | A (wt %) | (wt %) | p of Ni (%) | value | (%) |
| Example 1- | Formula R-5 + | 0.5 | 0.02 | 80 | 0.0063 | 9.7 |
| 1 | Formula | | | | | |
| | Rc-1 | | | | | |
| Example 2- | Formula R-5 + | 0.5 | 0.02 | 45 | 0.011 | 12.5 |
| 1 | Formula | | | | | |
| | Rc-1 | | | | | |
| Example 2- | Formula R-5 + | 0.5 | 0.02 | 55 | 0.0091 | 9.5 |
| 2 | Formula | | | | | |
| | Rc-1 | | | | | |
| Example 2- | Formula R-5 + | 0.5 | 0.02 | 60 | 0.0083 | 9.3 |
| 3 | Formula | | | | | |
| | Rc-1 | | | | | |
| Example 2- | Formula R-5 + | 0.5 | 0.02 | 65 | 0.0077 | 9.5 |
| 4 | Formula | | | | | |
| | Rc-1 | | | | | |
| Example 2- | Formula R-5 + | 0.5 | 0.02 | 70 | 0.0071 | 9.0 |
| 5 | Formula | | | | | |
| | Rc-1 | | | | | |
| Example 2- | Formula R-5 + | 0.5 | 0.02 | 75 | 0.0067 | 8.6 |
| 6 | Formula | | | | | |
| | Rc-1 | | | | | |
| Example 2- | Formula R-5 + | 0.5 | 0.02 | 85 | 0.0059 | 7.3 |
| 7 | Formula | | | | | |
| | Rc-1 | | | | | |
| Example 2- | Formula R-5 + | 0.5 | 0.02 | 90 | 0.0056 | 8.5 |
| 8 | Formula | | | | | |
| | Rc-1 | | | | | |
| Example 2- | Formula R-5 + | 0.5 | 0.02 | 95 | 0.0053 | 8.3 |
| 9 | Formula | | | | | |
| | Rc-1 | | | | | |
| Example 2- | Formula R-5 + | 0.1 | 0.02 | 85 | 0.0012 | 7.1 |
| 10 | Formula | | | | | |
| | Rc-1 | | | | | |
| Example 2- | Formula R-5 + | 0.1 | 0.5 | 85 | 0.0012 | 7.8 |
| 11 | Formula | | | | | |
| | Rc-1 | | | | | |
| Example 2- | Formula R-5 + | 0.07 | 0.02 | 90 | 0.0008 | 18.5 |
| 12 | Formula | | | | | |
| | Rc-1 | | | | | |
| Example 2- | Formula R-5 + | 5 | 0.02 | 50 | 0.1 | 18.3 |
| 13 | Formula | | | | | |
| | Rc-1 | | | | | |

Note:
In Table 2, “/” indicates the absence of the component.

Through comparison between Example 1-1 and Examples 2-1 to 2-9, it can be learned that the lithium-ion battery has a better high-temperature storage swelling rate when the mass percentage p of the nickel element in the total mass of the metal elements excluding the lithium element satisfies 50%≤p<10000.

Through comparison between Examples 2-1 to 2-10, 2-12, and 2-13, it can be learned that the high-temperature storage performance of the lithium-ion battery can be significantly improved when P2 satisfies 0.001≤P2≤0.08.

Table 3 shows related preparation parameters and performance parameters. In Examples 3-1 to 3-20, a cyclic ester is further added based on Example 1-1. Except for the differences shown in Table 3, other parameters are the same as those in Example 1-1.

TABLE 3

| | | | Mass | | | | High- |
|---|---|---|---|---|---|---|---|
| | Ionic liquid represented | | percentage | | | | temperature |
| | by formula R | | B of | Mass | | | storage |
| | | Mass | tungsten | percentage | Cyclic | P3 | swelling |
| | | percentage | element | p of | ester C | (A/C) | rate |
| Example | Type | A (wt %) | (wt %) | Ni (%) | (%) | value | (%) |
| Example | Formula | 0.5 | 0.02 | 80 | / | / | 9.7 |
| 1-1 | R-5 + | | | | | | |
| | Formula | | | | | | |
| | Rc-1 | | | | | | |
| Example | Formula | 0.5 | 0.02 | 80 | EC: 1 | 0.1 | 9.3 |
| 3-1 | R-5 + | | | | | | |
| | Formula | | | | | | |
| | Rc-1 | | | | | | |
| Example | Formula | 0.5 | 0.02 | 80 | EC: 2 | 0.05 | 9.2 |
| 3-2 | R-5 + | | | | | | |
| | Formula | | | | | | |
| | Rc-1 | | | | | | |
| Example | Formula | 0.5 | 0.02 | 80 | EC: 3 | 0.033 | 9.0 |
| 3-3 | R-5 + | | | | | | |
| | Formula | | | | | | |
| | Rc-1 | | | | | | |
| Example | Formula | 0.5 | 0.02 | 80 | EC: 5 | 0.02 | 8.8 |
| 3-4 | R-5 + | | | | | | |
| | Formula | | | | | | |
| | Rc-1 | | | | | | |
| Example | Formula | 0.5 | 0.02 | 80 | EC: 10 | 0.01 | 9.1 |
| 3-5 | R-5 + | | | | | | |
| | Formula | | | | | | |
| | Rc-1 | | | | | | |
| Example | Formula | 0.5 | 0.02 | 80 | EC: 15 | 0.007 | 9.5 |
| 3-6 | R-5 + | | | | | | |
| | Formula | | | | | | |
| | Rc-1 | | | | | | |
| Example | Formula | 0.5 | 0.02 | 80 | VC: 1 | 0.1 | 8.6 |
| 3-7 | R-5 + | | | | | | |
| | Formula | | | | | | |
| | Rc-1 | | | | | | |
| Example | Formula | 0.5 | 0.02 | 80 | VC: 3 | 0.033 | 8.3 |
| 3-8 | R-5 + | | | | | | |
| | Formula | | | | | | |
| | Rc-1 | | | | | | |
| Example | Formula | 0.5 | 0.02 | 80 | FEC: 2 | 0.05 | 9.1 |
| 3-9 | R-5 + | | | | | | |
| | Formula | | | | | | |
| | Rc-1 | | | | | | |
| Example | Formula | 0.5 | 0.02 | 80 | FEC: 5 | 0.02 | 9.4 |
| 3-10 | R-5 + | | | | | | |
| | Formula | | | | | | |
| | Rc-1 | | | | | | |
| Example | Formula | 0.5 | 0.02 | 80 | EC: 5; | 0.01 | 6.8 |
| 3-11 | R-5 + | | | | VC: 5 | | |
| | Formula | | | | | | |
| | Rc-1 | | | | | | |
| Example | Formula | 0.5 | 0.02 | 80 | ECF: | 0.02 | 8.5 |
| 3-12 | R-5 + | | | | 2.5; EC: | | |
| | Formula | | | | 2.5 | | |
| | Rc-1 | | | | | | |
| Example | Formula | 0.5 | 0.02 | 80 | FEC: 5; | 0.01 | 8.1 |
| 3-13 | R-5 + | | | | VC: 5 | | |
| | Formula | | | | | | |
| | Rc-1 | | | | | | |
| Example | Formula | 0.5 | 0.02 | 80 | EC: 5; | 0.007 | 7.7 |
| 3-14 | R-5 + | | | | VC: 5; | | |
| | Formula | | | | FEC: 5 | | |
| | Rc-1 | | | | | | |
| Example | Formula | 0.1 | 0.02 | 85 | EC: 5; | 0.01 | 6.2 |
| 3-15 | R-5 + | | | | VC: 5 | | |
| | Formula | | | | | | |
| | Rc-1 | | | | | | |
| Example | Formula | 1.0 | 0.02 | 85 | EC: 5; | 0.1 | 7.1 |
| 3-16 | R-5 + | | | | VC: 5 | | |
| | Formula | | | | | | |
| | Rc-1 | | | | | | |
| Example | Formula | 1.0 | 0.05 | 85 | EC: 5; | 0.1 | 8.5 |
| 3-17 | R-5 + | | | | VC: 5 | | |
| | Formula | | | | | | |
| | Rc-1 | | | | | | |
| Example | Formula | 0.1 | 0.02 | 90 | EC: 5; | 0.01 | 6.5 |
| 3-18 | R-5 + | | | | VC: 5 | | |
| | Formula | | | | | | |
| | Rc-1 | | | | | | |
| Example | Formula | 0.08 | 0.02 | 80 | EC: 20 | 0.004 | 9.5 |
| 3-19 | R-5 + | | | | | | |
| | Formula | | | | | | |
| | Rc-1 | | | | | | |
| Example | Formula | 3 | 0.02 | 80 | EC: 0.5 | 6.0 | 9.8 |
| 3-20 | R-5 + | | | | | | |
| | Formula | | | | | | |
| | Rc-1 | | | | | | |

Through comparison between Examples 3- to 3-20, it can be learned that the high-temperature storage performance of the lithium-ion battery can be significantly improved by adding an appropriate amount of cyclic ester to the electrolyte to make P3 satisfies 0.005≤P3≤3. Through comparison between Examples 3-1 to 3-6, it can be learned that as the amount of added cyclic ester increases, the high-temperature storage swelling rate of the lithium-ion battery first decreases and then increases. Through comparison between Examples 3-5, 3-11, and 3-13, it can be learned that the high-temperature storage swelling rate of the lithium-ion battery can be further improved by adding a combination of different types of cyclic esters.

Table 4 shows related preparation parameters and performance parameters. In Examples 4-1 to 4-27, a cyclic ester and/or a cyclic sulfur-oxygen double bond compound is further added based on Example 1-1. Except for the differences shown in Table 4, other parameters are the same as those in Example 1-1.

TABLE 4

| | Ionic liquid | | | | | | | |
|---|---|---|---|---|---|---|---|---|
| | represented by | | Mass | | | | | |
| | formula R | | percentage | | | | | High- |
| | | Mass | B of | Mass | Cyclic | Cyclic sulfur- | | temperature |
| | | percentage | tungsten | percentage | ester | oxygen double | P4 | storage |
| | | A | element | p of Ni | C | bond compound | (A/S) | swelling |
| Example | Type | (wt %) | (wt %) | (%) | (%) | S (%) | value | rate (%) |
| Example | Formula | 0.5 | 0.02 | 80 | / | / | / | 9.7 |
| 1-1 | R-5 + | | | | | | | |
| | Formula | | | | | | | |
| | Rc-1 | | | | | | | |
| Example | Formula | 0.5 | 0.02 | 80 | / | PS: 1 | 0.5 | 9.5 |
| 4-1 | R-5 + | | | | | | | |
| | Formula | | | | | | | |
| | Rc-1 | | | | | | | |
| Example | Formula | 0.5 | 0.02 | 80 | / | PS: 5 | 0.1 | 9.2 |
| 4-2 | R-5 + | | | | | | | |
| | Formula | | | | | | | |
| | Rc-1 | | | | | | | |
| Example | Formula | 0.5 | 0.02 | 80 | / | PS: 10 | 0.05 | 9.3 |
| 4-3 | R-5 + | | | | | | | |
| | Formula | | | | | | | |
| | Rc-1 | | | | | | | |
| Example | Formula | 0.5 | 0.02 | 80 | / | DTD: 1 | 0.5 | 9.0 |
| 4-4 | R-5 + | | | | | | | |
| | Formula | | | | | | | |
| | Rc-1 | | | | | | | |
| Example | Formula | 0.5 | 0.02 | 80 | / | DTD: 5 | 0.1 | 8.8 |
| 4-5 | R-5 + | | | | | | | |
| | Formula | | | | | | | |
| | Rc-1 | | | | | | | |
| Example | Formula | 0.5 | 0.02 | 80 | / | DTD: 10 | 0.0 | 8.5 |
| 4-6 | R-5 + | | | | | | 5 | |
| | Formula | | | | | | | |
| | Rc-1 | | | | | | | |
| Example | Formula | 0.5 | 0.02 | 80 | / | MMDS: 1 | 0.5 | 9.3 |
| 4-7 | R-5 + | | | | | | | |
| | Formula | | | | | | | |
| | Rc-1 | | | | | | | |
| Example | Formula | 0.5 | 0.02 | 80 | / | MMDS: 5 | 0.1 | 9.0 |
| 4-8 | R-5 + | | | | | | | |
| | Formula | | | | | | | |
| | Rc-1 | | | | | | | |
| Example | Formula | 0.5 | 0.02 | 80 | / | MMDS: 10 | 0.05 | 8.7 |
| 4-9 | R-5 + | | | | | | | |
| | Formula | | | | | | | |
| | Rc-1 | | | | | | | |
| Example | Formula | 0.5 | 0.02 | 80 | / | PS: 2.5; DTD: | 0.1 | 7.0 |
| 4-10 | R-5 + | | | | | 2.5 | | |
| | Formula | | | | | | | |
| | Rc-1 | | | | | | | |
| Example | Formula | 0.5 | 0.02 | 80 | / | PS: 2.5; MMDS: | 0.1 | 8.5 |
| 4-11 | R-5 + | | | | | 2.5 | | |
| | Formula | | | | | | | |
| | Rc-1 | | | | | | | |
| Example | Formula | 0.5 | 0.02 | 80 | / | DTD: 2.5; | 0.1 | 8.1 |
| 4-12 | R-5 + | | | | | MMDS: 2.5 | | |
| | Formula | | | | | | | |
| | Rc-1 | | | | | | | |
| Example | Formula | 0.5 | 0.02 | 80 | / | PS: 1; DTD: 2; | 0.1 | 7.8 |
| 4-13 | R-5 + | | | | | MMDS: 2 | | |
| | Formula | | | | | | | |
| | Rc-1 | | | | | | | |
| Example | Formula | 0.5 | 0.02 | 80 | / | PS: 3; DTD: 3; | 0.0 | 7.2 |
| 4-14 | R-5 + | | | | | MMDS: 4 | 5 | |
| | Formula | | | | | | | |
| | Rc-1 | | | | | | | |
| Example | Formula | 0.5 | 0.02 | 80 | EC: | PS: 2.5; DTD: | 0.1 | 6.8 |
| 4-15 | R-5 + | | | | 5 | 2.5 | | |
| | Formula | | | | | | | |
| | Rc-1 | | | | | | | |
| Example | Formula | 0.5 | 0.02 | 80 | VC: | PS: 2.5; DTD: | 0.1 | 6.3 |
| 4-16 | R-5 + | | | | 3 | 2.5 | | |
| | Formula | | | | | | | |
| | Rc-1 | | | | | | | |
| Example | Formula | 0.5 | 0.02 | 80 | FEC: | PS: 2.5; DTD: | 0.1 | 6.9 |
| 4-17 | R-5 + | | | | 2 | 2.5 | | |
| | Formula | | | | | | | |
| | Rc-1 | | | | | | | |
| Example | Formula | 0.5 | 0.02 | 80 | EC: | PS: 2.5; DTD: | 0.1 | 4.5 |
| 4-18 | R-5 + | | | | 5; | 2.5 | | |
| | Formula | | | | VC: | | | |
| | Rc-1 | | | | 5 | | | |
| Example | Formula | 0.5 | 0.02 | 80 | EC: | PS: 2.5; DTD: | 0.1 | 6.2 |
| 4-19 | R-5 + | | | | 2.5; | 2.5 | | |
| | Formula | | | | FEC: | | | |
| | Rc-1 | | | | 2.5 | | | |
| Example | Formula | 0.5 | 0.02 | 80 | VC: | PS: 2.5; DTD: | 0.1 | 5.8 |
| 4-20 | R-5 + | | | | 2.5; | 2.5 | | |
| | Formula | | | | FEC: | | | |
| | Rc-1 | | | | 2.5 | | | |
| Example | Formula | 0.5 | 0.02 | 80 | EC: | PS: 2.5; DTD: | 0.1 | 5.9 |
| 4-21 | R-5 + | | | | 3; | 2.5 | | |
| | Formula | | | | VC: | | | |
| | Rc-1 | | | | 3; | | | |
| | | | | | FEC: | | | |
| | | | | | 4 | | | |
| Example | Formula | 0.1 | 0.02 | 85 | EC: | PS: 2.5; DTD: | 0.0 | 3.9 |
| 4-22 | R-5 + | | | | 5; | 2.5 | 2 | |
| | Formula | | | | VC: | | | |
| | Rc-1 | | | | 5 | | | |
| Example | Formula | 0.1 | 0.5 | 85 | EC: | PS: 2.5; DTD: | 0.0 | 4.2 |
| 4-23 | R-5 + | | | | 5; | 2.5 | 2 | |
| | Formula | | | | VC: | | | |
| | Rc-1 | | | | 5 | | | |
| Example | Formula | 1 | 0.02 | 85 | EC: | PS: 2.5; DTD: | 0.2 | 4.6 |
| 4-24 | R-5 + | | | | 5; | 2.5 | | |
| | Formula | | | | VC: | | | |
| | Rc-1 | | | | 5 | | | |
| Example | Formula | 0.1 | 0.02 | 90 | EC: | PS: 2.5; DTD: | 0.0 | 4.1 |
| 4-25 | R-5 + | | | | 5; | 2.5 | 2 | |
| | Formula | | | | VC: | | | |
| | Rc-1 | | | | 5 | | | |
| Example | Formula | 2 | 0.02 | 80 | / | PS: 1 | 2 | 9.6 |
| 4-26 | R-5 + | | | | | | | |
| | Formula | | | | | | | |
| | Rc-1 | | | | | | | |
| Example | Formula | 0.05 | 0.02 | 80 | / | PS: 10 | 0.0 | 9.5 |
| 4-27 | R-5 + | | | | | | 05 | |
| | Formula | | | | | | | |
| | Rc-1 | | | | | | | |

Through comparison between Example 1-1 and Examples 4-1 to 4-14, it can be learned that the high-temperature storage performance of the lithium-ion battery can be significantly improved by adding an appropriate amount of cyclic sulfur-oxygen double bond compound. Through comparison between Examples 4-1 to 4-3, 4-26, and 4-27, it can be learned that the high-temperature storage performance of the lithium-ion battery is better when P4 satisfies 0.01≤P4≤1. Through comparison between Examples 4-10 and 4-15 to 4-25, it can be learned that the high-temperature storage performance of the lithium-ion battery is better in a case that the combination of the cyclic ester and the cyclic sulfur-oxygen double bond compound is used, as compared to a case in which the cyclic ester or the cyclic sulfur-oxygen double bond compound is used alone.

The foregoing descriptions are merely preferred examples of this application and explanations of the technical principles used. Persons skilled in the art should understand that the related scope disclosed in this application is not limited to the technical solutions formed by a specific combination of the foregoing technical features, and should also cover other technical solutions formed by any combination of the foregoing technical features or their equivalent features, for example, the technical solution formed by replacement between the foregoing features and technical features having similar functions disclosed in this application.

What is claimed is:

1. An electrochemical apparatus, comprising:
a positive electrode plate and an electrolyte, wherein the positive electrode plate comprises a positive electrode active material layer, the positive electrode active material layer comprises a positive electrode active material, the positive electrode active material comprises a lithium composite oxide; the lithium composite oxide comprises the lithium element and at least one element selected from the cobalt element, the nickel element, the manganese element, or the aluminum element; a surface layer of the positive electrode active material has a rock salt phase structure and the surface layer of the positive electrode active material comprises the tungsten element; based on a total mass of the positive electrode active material, B is a mass percentage of the tungsten element, wherein 0.01%≤B≤1%; and
the electrolyte comprises an ionic liquid represented by a formula R: 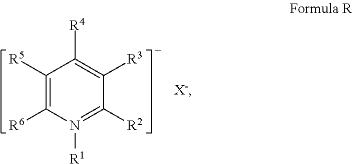
wherein in a cation, R¹ is selected from a C₁-C₈ alkyl group; R² to R⁶ each are independently selected from a hydrogen atom or a fluorine atom; and an anion X⁻ is selected from a chloride ion, a bromide ion, an iodide ion, a cyano group ion, a hexafluorophosphate radical, a perchlorate radical, a tetrafluoroborate radical, a bis(trifluoromethylsulfonyl)imide ion, or a sulfate radical; and
based on a total mass of the electrolyte, A is a mass percentage of the cation of the ionic liquid represented by the formula R, wherein 0.05%≤A≤5%, P1=A/B, and 0.08≤P1≤300.

2. The electrochemical apparatus according to claim 1, wherein in the positive electrode active material, p is a mass percentage of the nickel element in a total mass of metal elements excluding the lithium element, wherein 50%≤p<100%, P2=A/p, and 0.001≤P2≤0.08.

3. The electrochemical apparatus according to claim 2, wherein 0.01≤P2≤0.06.

4. The electrochemical apparatus according to claim 1, wherein 0.5≤P1≤50.

5. The electrochemical apparatus according to claim 1, wherein the electrolyte further comprises a cyclic ester; the cyclic ester comprises at least one of ethylene carbonate, vinylene carbonate, or fluoroethylene carbonate; and based on the total mass of the electrolyte, C is a mass percentage of the cyclic ester, wherein 1%≤C≤15%, P3=A/C, and 0.005≤P3≤3.

6. The electrochemical apparatus according to claim 1, wherein the cation of the ionic liquid represented by the formula R is selected from the following structures represented by Formula R-1 to Formula R-32:

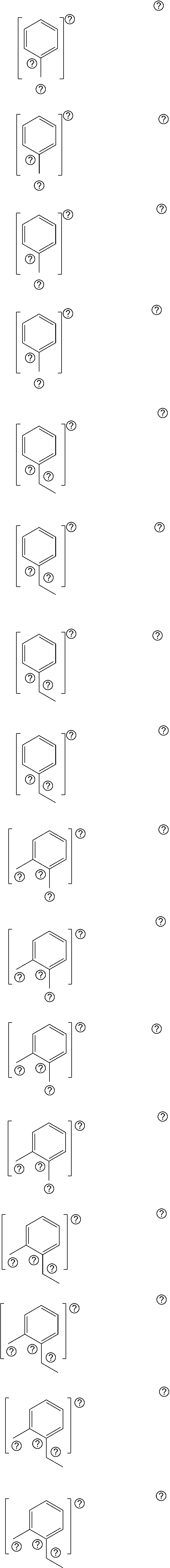

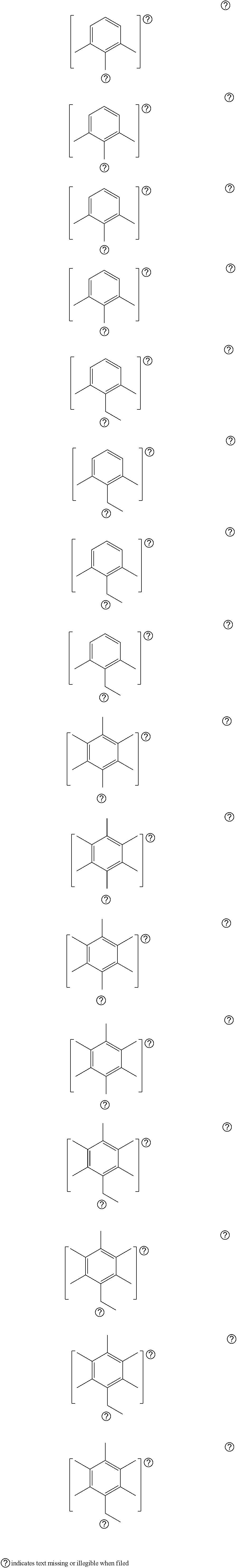

7. The electrochemical apparatus according to claim 1, wherein the sulfate radical is selected from the following structures represented by Formula Rc-1 to Formula Rc-13:

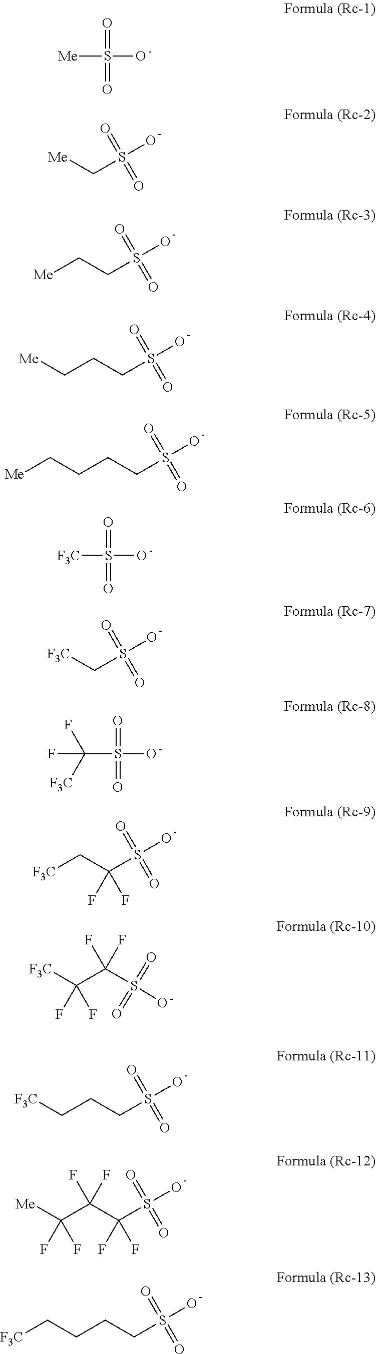

8. The electrochemical apparatus according to claim 1, wherein the electrolyte further comprises a cyclic sulfur-oxygen double bond compound; and the cyclic sulfur-oxygen double bond compound comprises at least one of 1,3-propane sultone, ethylene sulfate, or methylene methanedisulfonate; and
based on the total mass of the electrolyte, S is a mass percentage of the cyclic sulfur-oxygen double bond compound, wherein 1%≤S≤10%.

9. The electrochemical apparatus according to claim 8, wherein P4=A/S, and 0.01≤P4≤1.

10. An electronic apparatus, comprising an electrochemical apparatus, the electrochemical apparatus comprises a positive electrode plate and an electrolyte; wherein the positive electrode plate comprises a positive electrode active material layer, the positive electrode active material layer comprises a positive electrode active material, the positive electrode active material comprises a lithium composite oxide; the lithium composite oxide comprises the lithium element and at least one element selected from the cobalt element, the nickel element, the manganese element, or the aluminum element; a surface layer of the positive electrode active material has a rock salt phase structure and the surface layer of the positive electrode active material comprises the tungsten element; based on a total mass of the positive electrode active material, B is a mass percentage of the tungsten element, wherein 0.01%≤B≤1%; and
the electrolyte comprises an ionic liquid represented by a formula R: 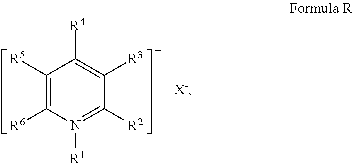
wherein in a cation, R¹ is selected from a C₁-C₈ alkyl group; R² to R⁶ each are independently selected from a hydrogen atom or a fluorine atom; and an anion X⁻ is selected from a chloride ion, a bromide ion, an iodide ion, a cyano group ion, a hexafluorophosphate radical, a perchlorate radical, a tetrafluoroborate radical, a bis(trifluoromethylsulfonyl)imide ion, or a sulfate radical; and
based on a total mass of the electrolyte, A is a mass percentage of the cation of the ionic liquid represented by the formula R, wherein 0.05%≤A≤5%, P1=A/B, and 0.08≤P1≤300.

11. The electronic apparatus according to claim 10, wherein in the positive electrode active material, p is a mass percentage of the nickel element in a total mass of metal elements excluding the lithium element, wherein 50%≤p≤100%, P2=A/p, and 0.001≤P2≤0.08.

12. The electronic apparatus according to claim 11, wherein 0.01≤P2≤0.06.

13. The electronic apparatus according to claim 10, wherein 0.5≤P1≤50.

14. The electronic apparatus according to claim 10, wherein the electrolyte further comprises a cyclic ester; the cyclic ester comprises at least one of ethylene carbonate, vinylene carbonate, or fluoroethylene carbonate; and based on the total mass of the electrolyte, C is a mass percentage of the cyclic ester, wherein 1%≤C≤15%, P3=A/C, and 0.005≤P3≤3.

15. The electronic apparatus according to claim 10, wherein the cation of the ionic liquid represented by the formula R is selected from the following structures represented by Formula R-1 to Formula R-32:

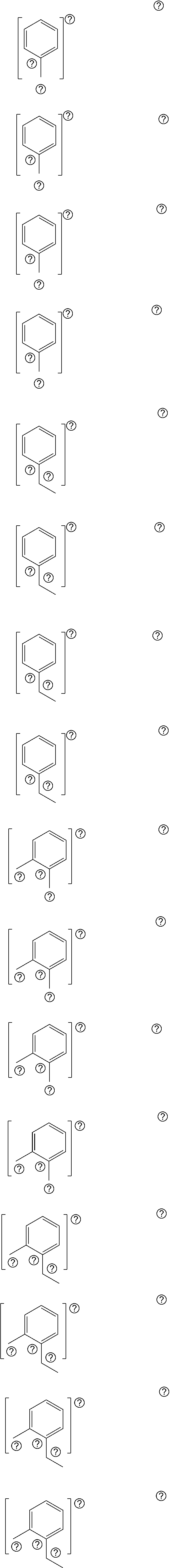

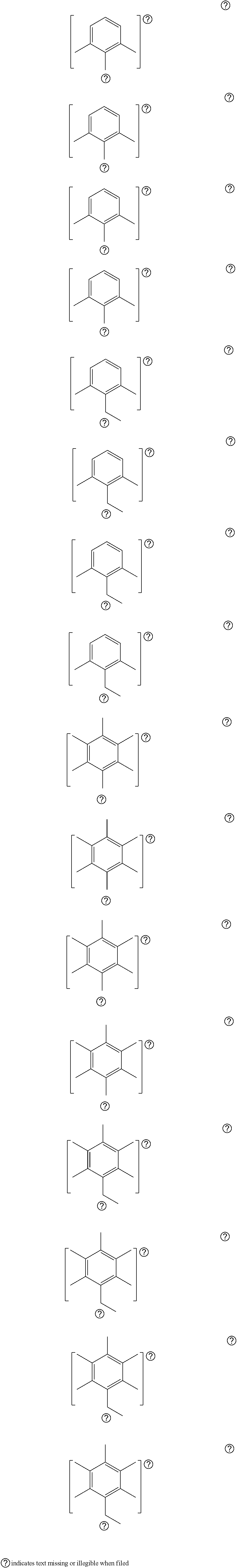

16. The electronic apparatus according to claim 10, wherein the sulfate radical is selected from the following structures represented by Formula Rc-1 to Formula Rc-13:

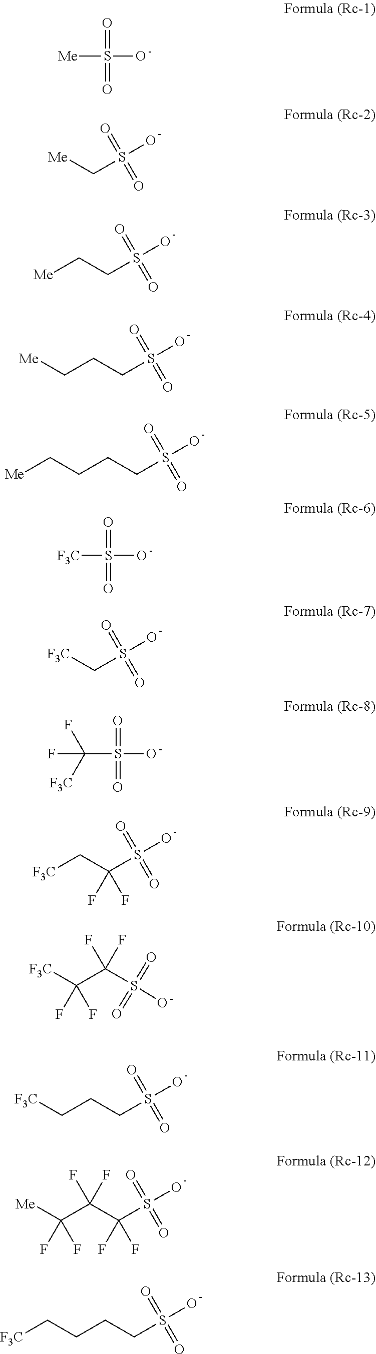

17. The electronic apparatus according to claim 10, wherein the electrolyte further comprises a cyclic sulfur-oxygen double bond compound; and the cyclic sulfur-oxygen double bond compound comprises at least one of 1,3-propane sultone, ethylene sulfate, or methylene methanedisulfonate; and
based on the total mass of the electrolyte, S is a mass percentage of the cyclic sulfur-oxygen double bond compound, wherein 100≤S≤1000.

18. The electrochemical apparatus according to claim 17, wherein P4=A/S, and 0.01≤P4≤1.
